(19) United States
(12) Patent Application Publication
(10) Pub. No.: US 2016/0009216 A1
(43) Pub. Date: Jan. 14, 2016

(54) LIGHT SOURCE MODULE AND LIGHTING DEVICE INCLUDING THE SAME

(71) Applicant: SAMSUNG ELECTRONICS CO., LTD., Suwon-si (KR)

(72) Inventors: Jin Kwan SONG, Suwon-si (KR); Ki Won CHOI, Suwon-si (KR)

(21) Appl. No.: 14/679,700

(22) Filed: Apr. 6, 2015

(30) Foreign Application Priority Data
Jul. 9, 2014 (KR) 10-2014-0086288

(51) Int. Cl. B60Q 1/04

(52) U.S. Cl. CPC B60Q 1/0408

(57) ABSTRACT

A light source module may include a frame part having a plurality of mounting regions arranged to be positioned on different levels and a plurality of light emitting units detachably mounted on the plurality of mounting regions. Each of the plurality of light emitting units includes a base disposed on each mounting region, and a light emitting device disposed above the base and positioned spaced-apart from the mounting region so as to form a space through which air flows, between the mounting region and the light emitting device.

### CROSS-REFERENCE TO RELATED APPLICATION

This application claims priority to Korean Patent Application No. 10-2014-0086288 filed on Jul. 9, 2014, with the Korean Intellectual Property Office, the entire content of which is incorporated herein by reference.

### TECHNICAL FIELD

The present disclosure relate to a light source module and a lighting device including the same.

### BACKGROUND

Light source modules having a plurality of light emitting diodes (LEDs) arranged according to a structure design have been widely used in vehicle headlamps. Such light source modules may have a structure of an array of LEDs determined depending on designs of headlamps variously designed for individual models of automobile.

The light source module used in the vehicle headlamps may be formed by pressing a heat sink for heat dissipation and a substrate for supplying power to a plurality of LEDs onto a plastic injection molded product formed as aback cover through a stacking process, and may have a structure in which the back cover, the heat sink, and the substrate are integrally stacked and fixed. Thus, it is necessary to design and manufacture a novel mold each time a new vehicle model is produced so as to fabricate a light source module in accordance with a lamp design of a corresponding automobile model, and such a mold manufactured as above needs to be kept and maintained until the corresponding automobile model is discontinued.

### SUMMARY OF THE INVENTION

An aspect of the present disclosure may provide a light source module capable of being commonly used by allowing for standardization of a structure supporting a light emitting device such as a heat sink, irrespective of an automobile model, and facilitating maintenance thereof, and a lighting device including the same.

According to an aspect of the present disclosure, a light source module may include: a frame part having a plurality of mounting regions arranged to be positioned on different levels; and a plurality of light emitting units detachably mounted on the plurality of mounting regions. Each of the plurality of light emitting units includes a base disposed on each mounting region, and a light emitting device disposed above the base and positioned spaced-apart from the mounting region so as to form a space through which air flows, between the mounting region and the light emitting device.

The light source module may further include a clip fixing the plurality of light emitting units to the frame part.

The clip may be detachably coupled the frame part and two light emitting units adjacent to each other with a portion of the frame part interposed therebetween, on a bottom of the frame part, to thereby fix the corresponding light emitting units to the frame part.

The clip may have an asymmetrical U-shape in which both end portions thereof have different lengths and are positioned on different levels, the both end portions of the clip being respectively provided with internally protruded protrusions.

The light emitting unit may further include a substrate interposed between the base and the light emitting device.

The base may include a support part above which the light emitting device is mounted and extension parts bent and extended from edges of the support part in a direction opposite to a direction in which the light emitting device is mounted.

The base may further include auxiliary extension parts bent and extended from the remaining edges of the support part in a direction opposite to a direction in which the light emitting device is mounted.

The substrate may be disposed on the support part and be extended along the extension parts.

The frame part may include a plurality of first frames respectively having the mounting regions and a plurality of second frames provided between the plurality of first frames and connecting the plurality of first frames to each other.

The plurality of first frames and the plurality of second frames may be alternately connected and extended, and the plurality of first frames may be formed in a stepped manner so as to be positioned on different levels.

Each of the first frames may include a mounting surface on which the light emitting unit is disposed, and side walls forming a space defining each mounting region, together with the mounting surface.

The light source module may further include a heat radiating hole in a central portion of the mounting surface in order to allow air to flow through the heat radiating hole.

According to another aspect of the present disclosure, a lighting device may include a light source module; a housing supporting the light source module; and a cover coupled to the housing and covering the light source module.

The lighting device may further include a reflector reflecting light of the light source module.

The reflector may include a plurality of reflective surfaces and a plurality of through holes provided in respective bottom surfaces of the plurality of reflective surfaces, and the plurality of light emitting units of the light source module may be respectively exposed to the plurality of reflective surfaces through the plurality of through holes.

According to another aspect of the present disclosure, a light source module may include a frame part having a plurality of first frames positioned on different levels and a plurality of light emitting units . Each first frame may include a side wall and a plurality of guide members protruding from a mounting surface of each first frame. Each light emitting unit may include a light emitting device, and a base including a support part on which the light emitting device is mounted and extension parts bent and extended from edges of the support part in a direction opposite to a direction in which the light emitting device is mounted. The extension parts of the base of one of the plurality of light emitting units may be detachably mounted between the guide members and the side wall of one of the plurality of first frames.

A length of the extension parts may be greater than a protruded length of the guide members so as to form a space through which air flows, between the mounting surface and the light emitting device.

The light source module may further include a clip fixing the plurality of light emitting units to the frame part.

The clip may be detachably coupled the frame part and two light emitting units adjacent to each other with a portion of the frame part interposed therebetween, on a bottom of the frame part, and fix the corresponding light emitting units to the frame part.

The clip may have an asymmetrical U-shape in which both end portions thereof have different lengths and are positioned on different levels, the both end portions of the clip being respectively provided with internally protruded protrusions.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic perspective view of a light source module according to an exemplary embodiment of the present invention;

FIG. 2 is an exploded perspective view of the light source module shown in FIG. 1;

FIG. 3 is a schematic plan view of amounting region in the light source module of FIG. 1;

FIG. 4 is a schematic exploded perspective view of a light emitting unit in the light source module of FIG. 1;

FIG. 5 is a schematic perspective view of a light source module according to another exemplary embodiment of the present invention;

FIG. 6 is an exploded perspective view of the light source module shown in FIG. 5;

FIG. 7 is a schematic cross-sectional view of the light source module shown in FIG. 5;

FIG. 8 is a schematic perspective view illustrating a form in which a clip is coupled to a base of a light emitting unit in the light source module shown in FIG. 5;

FIG. 9 is a schematic perspective view of a light source module according to another exemplary embodiment of the present invention;

FIG. 10 is a schematic perspective view of a frame part in the light source module of FIG. 9;

FIG. 11 is a plan view of FIG. 10;

FIG. 12 is a schematic exploded perspective view of a light emitting unit in the light source module of FIG. 9;

FIG. 13 is a schematic cross-sectional view of a light emitting device employable in the light source module according to an exemplary embodiment of the present invention;

FIG. 14 is the CIE 1931 coordinate system;

FIGS. 15 through 17 are cross-sectional views illustrating various examples of a light emitting diode chip employable in a light source module according to an exemplary embodiment of the present invention;

FIG. 18 is a schematic perspective view of a lighting device according to an exemplary embodiment of the present invention; and

FIG. 19 is a schematic perspective view illustrating another example of the lighting device of FIG. 18.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements .

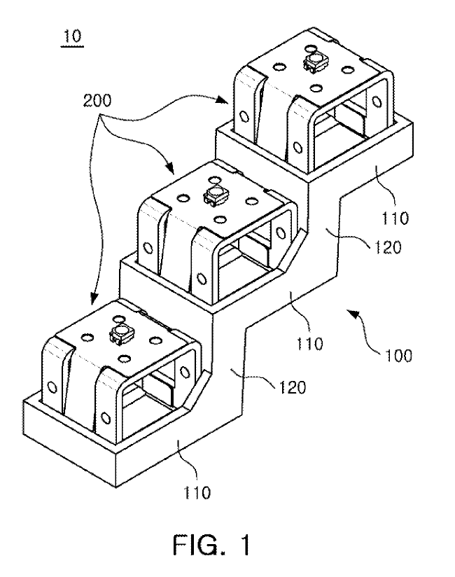

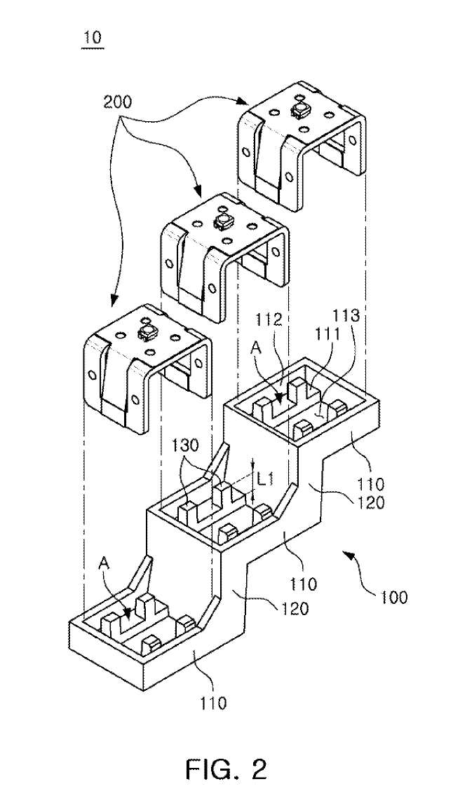

FIG. 1 is a schematic perspective view of a light source module according to an exemplary embodiment of the present invention. FIG. 2 is an exploded perspective view of the light source module shown in FIG. 1.

As illustrated in FIGS. 1 and 2, a light source module 10 according to an exemplary embodiment of the present invention may be configured to include a frame part 100 having a plurality of mounting regions and a plurality of light emitting units 200 detachably mounted on the plurality of mounting regions, respectively.

The frame part 100 may have a plurality of mounting regions A disposed on different levels.

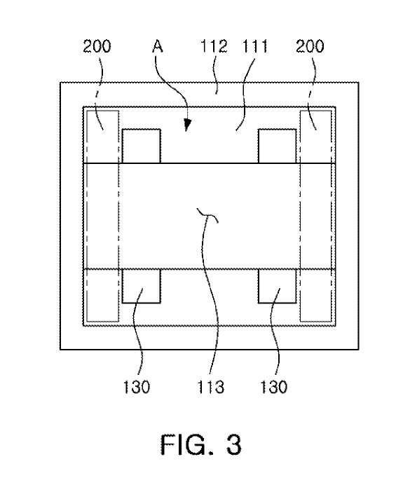

FIGS. 2 and 3 schematically illustrate the frame part 100 and the mounting regions A according to an exemplary embodiment of the present invention. As illustrated in FIGS. 2 and 3, the frame part 100 may include a plurality of first frames 110 respectively having the mounting regions A in which the light emitting units 200 to be described later are assembled and mounted and a plurality of second frames 120 provided between the plurality of first frames 110 and connecting the plurality of first frames 110 to each other.

In detail, the plurality of first frames 110 may be disposed on different levels and accordingly, the plurality of mounting regions A may be positioned on different levels. That is, the plurality of first frames 110 may be disposed at different heights. The plurality of second frames 120 may be positioned between the plurality of first frames 110 to connect two first frames 110 adjacent to each other and positioned on different levels to each other. That is, each of the plurality of second frames 120 may be extended downwardly from one end of one first frame 110 disposed in a relatively high position and may be connected to the other end of another first frame 110 disposed in a relatively low position.

The exemplary embodiment illustrates a case in which the second frames 120 are extended to be perpendicular with respect to the first frame 110, but the present disclosure is not limited thereto. For example, the second frames 120 may be inclinedly extended at a predetermined angle.

The frame part 100 maybe formed such that the plurality of first frames 110 and the plurality of second frames 120 may be extended and alternately connected to each other. In addition, the plurality of first frames 110 may be positioned on different levels and be formed in a stepped manner.

Each of the first frames 110 may include a mounting surface 111 on which the light emitting unit is disposed, and side walls 112 forming a space defining each mounting region A, together with the mounting surface 111. In addition, one ends of the second frames 120 may be extended from the side walls 112 and the other ends thereof may configure portions of the side walls 112 of the remaining first frames 110. Therefore, the first frames 110 and the second frames 120 may be integrally connected to each other.

The exemplary embodiment illustrates a case in which the mounting surface 111 has a quadrangular shape and the side walls 112 form four side surfaces, but the present disclosure is not limited thereto. For example, a shape of the mounting region A defined by the mounting surface 111 and the side walls 112 may be variously modified.

A heat radiating hole 113 may be provided in a central portion of the mounting surface 111 in order to allow air to flow through the heat radiating hole 113. Due to the heat radiating hole 113, the mounting region A may have an open bottom surface.

Guide members 130 may be respectively provided on two sides of the mounting surface 111 with the heat radiating hole 113 disposed between the guide members 130. The guide members 130 may protrude from the mounting surface 111 and have a protruded length L1. The guide members 130 may serve to guide the mounting of the light emitting unit 200 to be described later and to allow for fixation of the light emitting unit 200. The guide members 130 may be selectively provided. Therefore, depending on exemplary embodiments, the guide members 130 may be omitted.

The exemplary embodiment illustrates a case in which the frame part 100 is composed of three first frames 110 and two second frames 120, but the present disclosure is not limited thereto. For example, the amounts of the first frames 110 and the second frames 120 may be variously modified depending on vehicle models or structural designs of lighting devices.

In addition, the exemplary embodiment illustrates a case in which the first frames 110 and the second frames 120 are extended in one direction, such that the frame part 100 generally has a linear shape, but the present disclosure is not limited thereto. For example, the frame part 100 may have a curved shape having a curved surface.

The frame part 100 may be formed by a scheme of injecting a resin such as PC (polycarbonate) or PMMA (polymethyl methacrylate) into a mold and solidifying the resin. For example, molding schemes such as an injection molding scheme, a transfer molding scheme, a compression molding scheme or the like may be used.

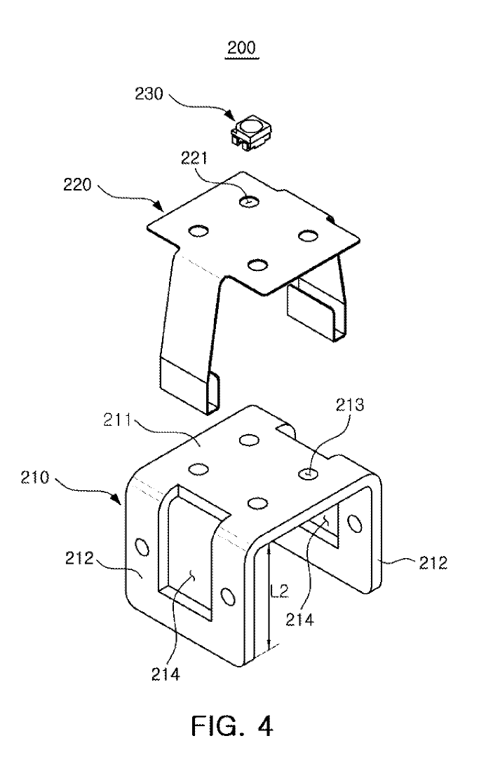

The light emitting units 200 may be detachably mounted on the plurality of mounting regions A and may individually emit light. FIG. 4 schematically illustrates a single light emitting unit 200. As in FIGS. 1 and 4, the light emitting unit 200 may include a base 210 disposed on the mounting region A, a substrate 220 provided on the base 210, and a light emitting device 230 disposed on the substrate 220.

The base 210, a type of a heat sink detachably mounted on the mounting region A, may allow the light emitting device 230 (to be described later) to be mounted thereon and be supported thereby, and may discharge heat generated by the light emitting device 230 externally.

The base 210 may include a support part 211 above which the light emitting device 230 is mounted and extension parts 212 bent and extended from edges of the support part 211 in a direction opposite to a direction in which the light emitting device 230 is mounted. The support part 211 and the extension parts 212 maybe integrally formed by press-processing a single metal plate, for example. The extension parts have a length of L2.

The support part 211 may have arrangement holes 213 guiding an arrangement position of the substrate 220 to be disposed on an upper surface of the support part 211. The extension parts 212 may be provided as a pair of extension parts 212 provided in parallel to be opposed to each other. Thus, the base part 210 may have a U-shape. In addition, each of the extension parts 212 may include an opening 214, such that a central portion thereof may be opened.

The exemplary embodiment illustrates a case in which the support part 211 has a quadrangular plate shape and a pair of extension parts 212 are provided at both opposing ends of the support part 211, but the present disclosure is not limited thereto. For example, the support part 211 may have a polygonal shape other than a quadrangular shape, and the extension parts 212 may be provided as a plurality of pairs of extension parts 212.

In this manner, in the base 210 according to the exemplary embodiment, the support part 211 above which the light emitting device 230 is mounted may be disposed above and spaced apart from the mounting region A of the first frame 110 by the pair of extension parts 212, and air may flow through an open space between the pair of extension parts 212, whereby effects of improving heat dissipation efficiency according to natural convection may be expected.

In addition, the mounting surface 111 of the first frame 110 on which the base 210 is mounted may have the bottom opened through the heat radiating hole 113. Therefore, the flow of air may be maintained through the space between the extension parts 212, while air flow may be maintained through the heat radiating hole 113, whereby heat dissipation efficiency may be improved.

Meanwhile, the base 210 may be formed of a material having superior thermal conductivity in order to improve heat dissipation efficiency. For example, the base 210 may be formed of a metal material, but is not limited thereto. In addition, the base 210 may be mass-produced through a progressive mold, a semi-progressive mold, a die casting mold or the like.

The substrate 220 may be attached to the support part 211 using an adhesive or the like. The substrate 220 may be a flexible printed circuit board able to be freely bent and be easily deformed into various shapes. In addition to this, the substrate 220 may be a general FR4-type printed circuit board and may be formed of an organic resin material including epoxy, triazine, silicone, polyimide and the like, or other organic resin materials. Alternatively, the substrate 220 may be formed of a ceramic material such as silicon nitride, AIN, Al₂O₃ or the like, a metal, or a metal compound, and examples thereof may include a metal core printed circuit board (MCPCB), a metal copper clad laminate (MCCL) and the like.

The substrate 220 may be provided with fiducial marks 221 corresponding to the arrangement holes 213 of the support part 211. Through the fiducial marks 221, a correct mounting position of the substrate 220 may be easily determined.

The substrate 220 may be disposed on the support part 211 to be fixed thereto and may be partially extended along the extension parts 212. In this case, the substrate 220 may cross over the opening 214 of the extension part 212 and be extended to an edge of the extension part 212. Further, the substrate 220 may be extended toward an inner side surface of the extension part 212 in such a manner as to cover the edge of the extension part 212. Thus, the substrate 220 may be further stably, mechanically coupled to the base 210.

The light emitting device 230 may be a photoelectric device generating light of a predetermined wavelength by driving power applied from the outside. Examples of the light emitting device 230 may include a semiconductor light emitting diode (LED) chip including an n-type semiconductor layer, a p-type semiconductor layer, and an active layer interposed between the semiconductor layers, or a package including the LED chip therein.

The light emitting device 230 may emit blue light, green light or red light in accordance with a material contained therein or a combination of phosphors, and may also emit white light, ultraviolet light or the like. The light emitting device 230 may be variously configured as the same type of devices generating light having the same wavelength or different types of devices generating different wavelengths of light. In addition, the light emitting device 230 may be variously configured depending on power levels such as 0.5 W and 1 W.

As the light emitting device 230, light emitting diode (LED) chips having various structures or variously shaped LED packages including such LED chips therein may be used. The exemplary embodiment exemplifies a case in which the light emitting device 230 is an LED package, but the present disclosure is not limited thereto. The detailed configuration and structure of the light emitting device 230 will be explained later on.

In this manner, the light source module 10 according to the exemplary embodiment may be used as a common module by adjusting the number of light emitting units 200 mounted on the frame part 100, irrespectively of automobile models. For example, automobiles' daytime running lights may be variously designed depending on automobile models, and according to the related art, a light source module having a light source and a heat sink structure that are integrally formed and matched with each automobile model is individually manufactured. To this end, it may be necessary to separately manufacture a mold for each automobile model.

According to the exemplary embodiment, the light source module may be easily manufactured in such a manner that a greater or lesser amount of the light emitting units 200 having block shapes may be mounted suitably for each model of automobile. Thus, it is unnecessary to manufacture a separate light source module having a light source and a heat sink structure formed integrally with each other for each model of automobile, as in the related art. Further, it is unnecessary to manufacture a separate mold in order to manufacture the light source module and accordingly, effects of reducing investment costs and manufacturing costs may be expected.

In addition, since the light source module 10 according to the exemplary embodiment may have a structure in which the light emitting units 200 capable of individually emitting light are selectively assembled and mounted in the frame part 100, in a case in which some light emitting devices of the plurality of light emitting units 200 are broken and accordingly, are not operated, only the light emitting units 200 having the broken light emitting devices may be removed and replaced to thereby facilitate maintenance. Thus, it may be advantageous in that defects such as shortcomings in which the entirety of the light source module may be discarded and replaced with a new module as in the related art, and the consequent increase in costs may not be caused.

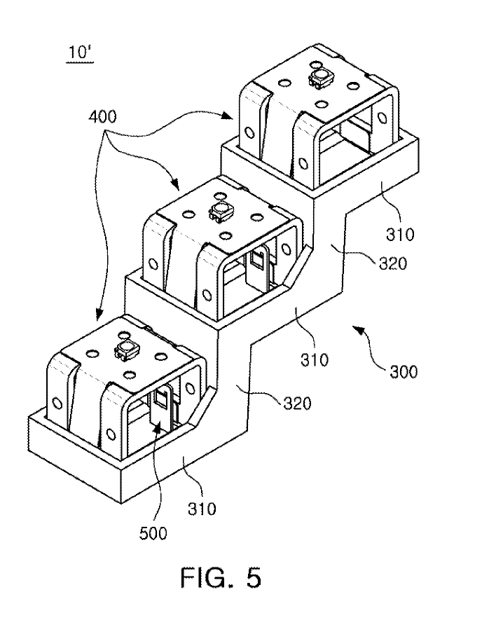

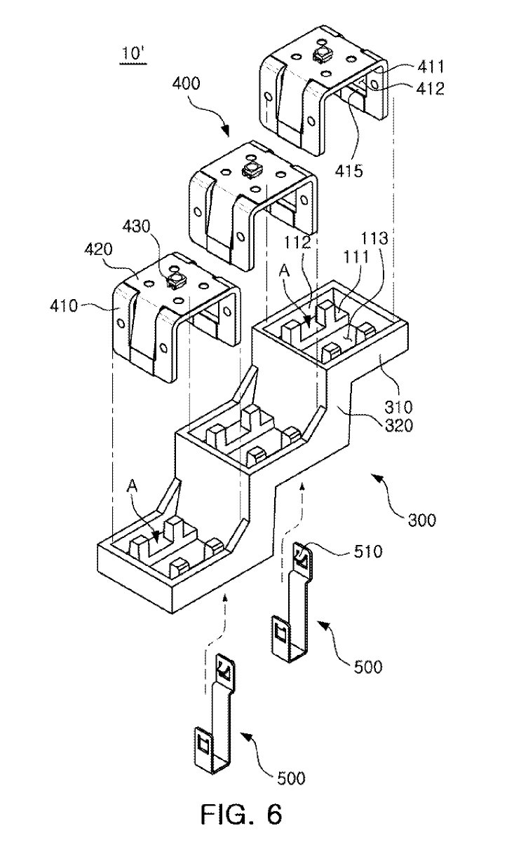

FIGS. 5 through 8 illustrate a light source module according to another exemplary embodiment of the present invention. FIG. 5 is a schematic perspective view of a light source module according to another exemplary embodiment of the present invention. FIG. 6 is an exploded perspective view of the light source module shown in FIG. 5.

A configuration of alight source module shown in FIGS. 5 through 8 is substantially the same as that illustrated in the embodiment of FIGS. 1 through 4, in terms of the basic structure thereof. However, since the light source module shown in FIGS. 5 through 8 is different from that illustrated in the embodiment of FIGS. 1 through 4 in terms of further including clips fixing a plurality of light emitting units to one another, hereinafter, descriptions overlapped with those of the foregoing embodiment will be omitted and a configuration of the clips will mainly be explained.

As in FIGS. 5 through 8, a light source module 10′ according to the exemplary embodiment may be configured to include a frame part 300 having a plurality of mounting regions A, a plurality of light emitting units 400 detachably mounted on the plurality of mounting regions A, and clips 500 fixing the plurality of light emitting units 400 to one another.

The frame part 300 may include a plurality of first frames 310 respectively having the mounting regions A in which the light emitting units 400 are assembled and mounted and a plurality of second frames 320 provided between the plurality of first frames 310 and connecting the plurality of first frames 310 to each other.

The plurality of first frames 310 may be disposed on different levels and accordingly, the plurality of mounting regions A may be positioned on different levels. The plurality of second frames 320 may be positioned between the plurality of first frames 310 to connect two first frames 310 adjacent to each other and positioned on different levels to each other. That is, the plurality of first frames 310 and the plurality of second frames 320 may be alternately connected and extended to form the frame part 300. In addition, the plurality of first frames 310 may be positioned on different levels and be formed in a stepped manner.

The light emitting units 400 may be detachably mounted on the plurality of mounting regions A and may emit light. Each of the light emitting units 400 may include a base 410 disposed on the mounting region A, a substrate 420 provided on the base 410, and a light emitting device 430 disposed on the substrate 420.

The base 410 may include a support part 411 above which the light emitting device 430 is mounted and extension parts 412 bent and extended from edges of the support part 411 in a direction opposite to a direction in which the light emitting device 430 is mounted. The support part 411 and the extension parts 412 maybe integrally formed by press-processing a single metal plate, for example.

Since the frame part 300 and the plurality of light emitting units 400 assembled in the frame part 300 are substantially the same as the frame part 100 and the light emitting units 200 shown in FIGS. 1 through 4, a detailed description thereof will be omitted.

Each of the clips 500 may be detachably inserted between two light emitting units 400 adjacent to each other with a portion of the frame part 300 interposed therebetween, to thereby fix the corresponding light emitting units 400 to the frame part 300.

As illustrated in FIG. 6, the clip 500 may have an asymmetrical U-shape in which end portions thereof have substantially different lengths. In addition, both end portions of the clip 500 extended at different lengths and positioned on different levels may be respectively provided with internally protruded protrusions 510. A difference in lengths between the both end portions may correspond to a difference in heights between the first frames 310 positioned on different levels.

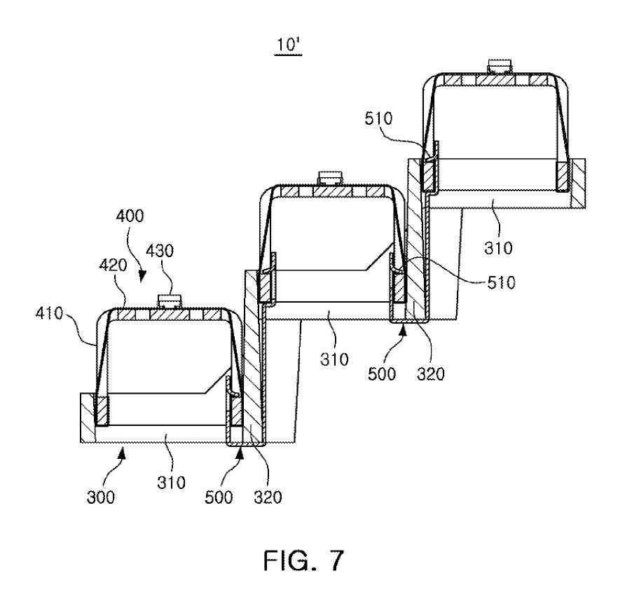

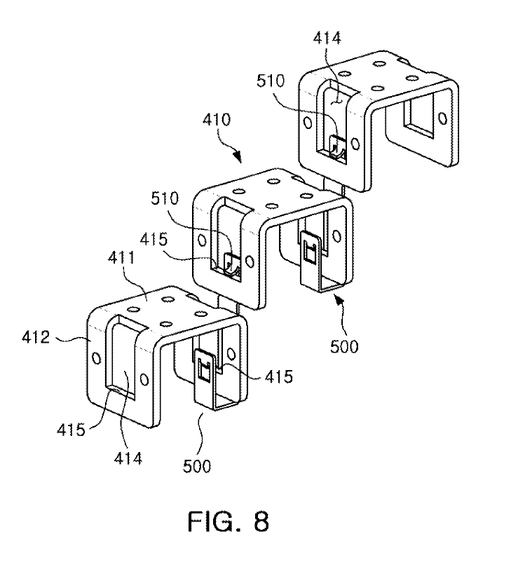

As illustrated in FIGS. 7 and 8, the clip 500 may be coupled to the second frame 320 and the extension parts 412 on both sides of two light emitting units 400 disposed in parallel to each other with the second frame 320 interposed between the two light emitting units 400, on the bottom of the frame part 300. In this case, the protrusions 510 provided on the both end portions of the clip 500 may be caught by and fixed to caught jaws 415 formed by openings 414 of the extension parts 412. Therefore, the light emitting units 400 may be further stably coupled to the frame part 300.

In this manner, the clip 500 according to the exemplary embodiment may allow for improvements in fixation force so as to prevent the light emitting unit 400 detachably mounted in the frame part 300 from being separated from the frame part 300 due to externally applied vibrations or impacts.

The clip 500 may be formed of an elastic material, for example, a metal such as aluminum, but the present disclosure is not limited thereto.

Meanwhile, the clip 500 may serve to electrically connect the plurality of light emitting units 400 to each other, as well as physically fixing the light emitting units 400 to the frame part 300. For example, the clip 500 may electrically connect the light emitting units 400 to each other in such a manner as to be electrically connected to circuit patterns (not shown) of the substrate 420 through the protrusions 510 thereof caught by and fixed to the caught jaws 415 of the extension parts 412.

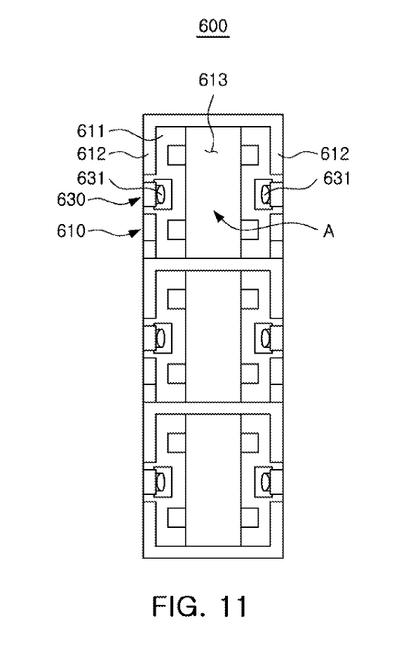

FIGS. 9 through 12 illustrate a light source module according to another exemplary embodiment of the present invention. FIG. 9 is a schematic perspective view of a light source module according to another exemplary embodiment of the present invention.

A configuration of alight source module shown in FIGS. 9 through 12 is substantially the same as that illustrated in the embodiment of FIGS. 1 through 8, in terms of the basic structure thereof. However, since the light source module shown in FIGS. 9 through 12 is different from that illustrated in the embodiment of FIGS. 1 through 8 in terms of a fixing element provided in a frame part to allow light emitting units to be detachably mounted in a frame part, hereinafter, descriptions overlapped with those of the foregoing embodiment will be omitted and a configuration of the clips will mainly be explained.

As in FIGS. 9 through 12, a light source module 10″ according to the exemplary embodiment may be configured to include a frame part 600 having a plurality of mounting regions A, and a plurality of light emitting units 700 detachably mounted on the plurality of mounting regions A.

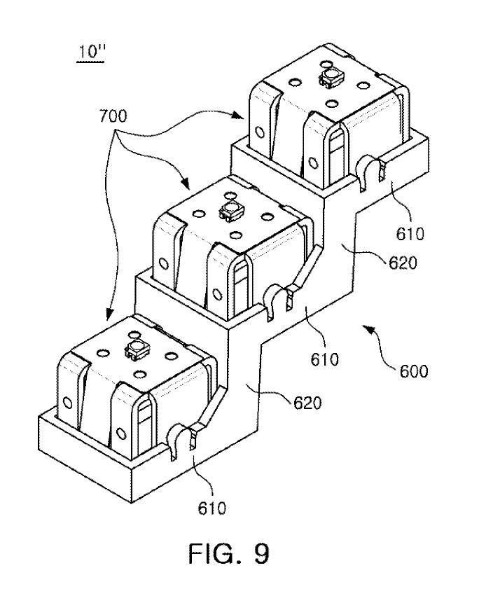

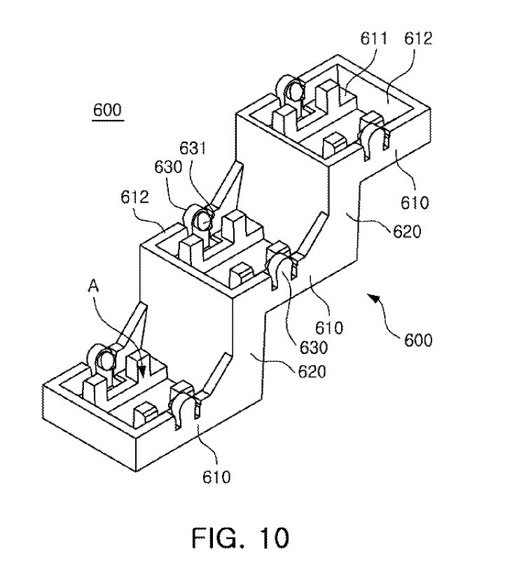

As in FIG. 10, the frame part 600 may include a plurality of first frames 610 respectively having the mounting regions A in which the light emitting units 700 are assembled and mounted and a plurality of second frames 620 provided between the plurality of first frames 610 and connecting the plurality of first frames 610 to each other.

The plurality of first frames 610 may be disposed on different levels and accordingly, the plurality of mounting regions A may be positioned on different levels. The plurality of second frames 620 may be positioned between the plurality of first frames 610 to connect two first frames 610 adjacent to each other and positioned on different levels. That is, the plurality of first frames 610 and the plurality of second frames 620 may be alternately connected and extended to form the frame part 600. In addition, the plurality of first frames 610 may be positioned on different levels and be formed in a stepped manner.

Each of the first frames 610 may include a mounting surface 611 on which each light emitting unit 700 is disposed, and side walls 612 forming a predetermined size of space defining each mounting region A, together with the mounting surface 611. In addition, one ends of the second frames 620 may be extended from the side walls 612 and the other ends thereof may configure portions of the side walls 612 of the remaining first frames 610. Therefore, the first frames 610 and the second frames 620 may be integrally connected to each other.

Fixing elements 630 may selectively fasten and fix a base 710 of the light emitting unit 700 thereto such that the light emitting unit 700 may be detachably mounted in the mounting region A. In detail, the fixing elements 630 may be elastically provided on side surfaces of the mounting region A contacting the base 710, that is, the side walls 612. The fixing elements 630 may be provided to face each other at two opposing side walls among the side walls 612.

The fixing elements 630 may include projection members 631 protruding toward the mounting region A. The projection members 631 may have downwardly inclined curved surfaces. Thus, in a case in which the light emitting unit 700 is mounted on the mounting surface 611, the base 710 thereof may slidably move along the curved surfaces to be disposed on the mounting surface 611.

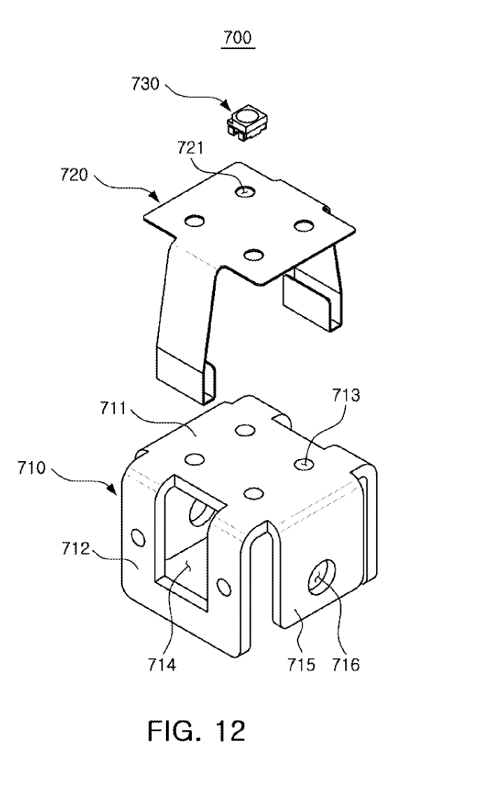

FIG. 12 schematically illustrates a single light emitting unit 700 according to the exemplary embodiment. The light emitting unit 700 may include the base 710 disposed on the mounting region A, a substrate 720 provided on the base 710, and a light emitting device 730 disposed on the substrate 720.

The base 710 may include a support part 711 above which the light emitting device 730 is mounted, extension parts 712 bent and extended from edges of the support part 711 in a direction opposite to a direction in which the light emitting device 730 is mounted, and auxiliary extension parts 715 bent and extended from the remaining edges of the support part 711 in a direction opposite to a direction in which the light emitting device 730 is mounted.

In a similar manner to the base 210 illustrated in FIG. 4, the support part 711 of the base 710 according to the exemplary embodiment may have arrangement holes 713. Each of the extension parts 712 may include an opening 714 formed therein.

The auxiliary extension parts 715 may be provided with coupling holes 716 into which the protruding projection members 631 are inserted at the time of mounting the light emitting unit 700 in the mounting region A. Thus, the base 710 mounted on the mounting region A may be stably fixed to the frame part by the projection members 631 of the fixing elements 630 being inserted into the coupling holes 716 of the auxiliary extension parts 715 to be caught thereby and fixed thereto. In addition, the projection members 631 may be pull out from the coupling holes 716, whereby the base 710 may be easily separated from the mounting region A .

The support part 711, the extension parts 712, and the auxiliary extension parts 715 may be integrally formed by press-processing a single metal plate, for example.

In this manner, according to the exemplary embodiment, the light emitting unit 700 may be easily mounted on the frame part 600 and be stably fixed thereto in a simple catching and fixing manner. In addition, the light emitting unit 700 may be detachable by the fixing elements 630 having elastic properties and be easily replaced, if necessary.

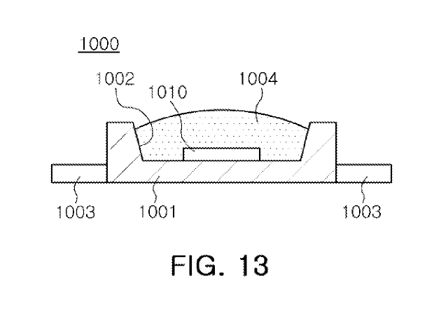

Hereinafter, a light emitting device employable in the light source module according to an exemplary embodiment of the present disclosure will be explained. FIG. 13 schematically illustrates a light emitting device employable in the light source module according to an exemplary embodiment of the present disclosure.

As illustrated in FIG. 13, a light emitting device 1000 according to an exemplary embodiment of the present disclosure may have a package structure in which an LED chip 1010 is mounted within a body 1001 having a reflective cup 1002.

The body 1001 may allow the LED chip 1010 to be mounted thereon and to be supported thereby, and may be formed of a white molding compound having a high degree of light reflectance, whereby effects of increasing the quantity of outwardly emitted light by reflecting light emitted from the LED chip 1010 may be provided. Such a white molding compound may include a thermosetting resin having high heat resistance or a silicon resin. In addition, a thermoplastic resin added with a white pigment and filler, a curing agent, a release agent, an antioxidant, an adhesion improver, or the like . In addition, the white molding compound may be formed of FR-4, CEM-3, an epoxy material, a ceramic material or the like. Further, the white molding compound may be formed of a metal such as aluminum (Al) .

The body 1001 may be provided with lead frames 1003 for electrical connection with an external power source. The lead frames 1003 may be formed of a metal such as aluminum, copper or the like, having excellent electrical conductivity. In a case in which the body 1001 is formed of a metal, an insulating material may be interposed between the body 1001 and the lead frames 1003.

The lead frames 1003 may be exposed to the reflective cup 1002 of the body 1001 through a bottom surface of the reflective cup 1002 on which the LED chip 1010 is mounted. The LED chip 1010 may be electrically connected to the exposed lead frames 1003.

A cross-section of the reflective cup 1002 exposed to an upper surface of the body 1001 maybe greater than the bottom surface of the reflective cup 1002. Here, the cross-section of the reflective cup 1002 exposed to the upper surface of the body 1001 may be defined as a light emitting surface.

Meanwhile, the LED chip 1010 may be enclosed by a sealing material 1004 formed within the reflective cup 1002 of the body 1001. The sealing material 1004 may contain a wavelength conversion material.

The wavelength conversion material may contain at least one or more phosphors excited by light generated by the LED chip 1010 and emitting light of different wavelengths. By doing so, a control may be performed such that various colors of light as well as white light may be emitted.

For example, in a case in which the LED chip 1010 emits blue light, white light may be emitted by combining yellow, green, red, and orange colored phosphors. In addition, the LED chip 1010 may be configured to include at least one of light emitting devices emitting violet, blue, green, red and ultraviolet light. In this case, the LED chip 1010 may adjust a color rendering index (CRI) from a natrium (Na) lamp (color rendering index: 40) level to a solar light (color rendering index: 100) level, and may generate various types of white light with color temperatures ranging from 2000 K to 20000 K. Also, if necessary, the LED chip 1010 may generate violet, blue, green, red or orange visible light or infrared light to adjust the color of light according to atmospheres and a user mood. Also, the LED chip 1010 may generate a specific wavelength of light for accelerating the growth of plants.

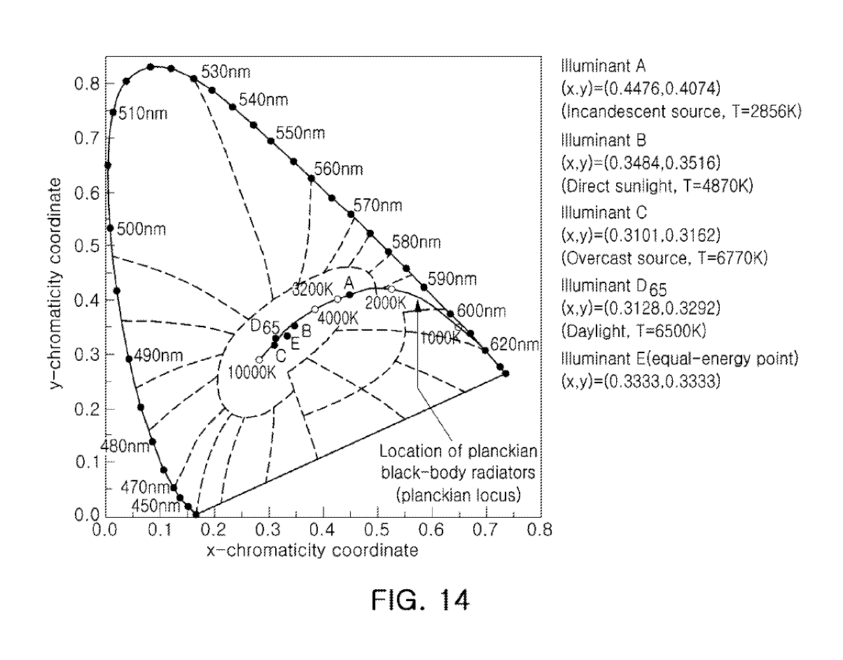

White light formed by combining yellow, green, red phosphors with the blue LED and/or combining green and red LEDs may have two or more peak wavelengths, and coordinates (x, y) thereof in the CIE 1931 coordinate system of FIG. 14 may be positioned on a line segment connecting (0.4476, 0.4074), (0.3484, 0.3516), (0.3101, 0.3162), (0.3128, 0.3292), and (0.3333, 0.3333). Alternatively, coordinates (x, y) thereof in the CIE 1931 coordinate system may be positioned in a region surrounded by the line segment and blackbody radiation spectrum. The color temperature of white light may range from 2000 K to 20000 K.

The phosphors may have the following compositional formulae and colors.

Oxides: yellow and green Y₃Al₅O₁₂:Ce, Tb₃Al₅O₁₂:Ce, Lu₃Al₅O₁₂ : Ce

Silicates: yellow and green (Ba,Sr)₂SiO₄:Eu, yellow and orange (Ba,Sr)₃SiO₅:Ce

Nitrides: green β-SiAlON:Eu, yellow La₃Si₆N₁₁:Ce, orange α-SiAlON:Eu, red CaAlSiN³:Eu, Sr₂Si₅N₈:Eu, SrSiAl₄N₇:Eu

Fluorides: KSF based red K₂SiF₆:Mn4+

The phosphor composition may basically accord with stoichiometry and respective elements may be substituted with other elements within respective groups in a periodic table of the elements. For example, Sr may be substituted with Ba, Ca, Mg or the like within the alkaline earth group (II) and Y may be substituted with lanthanum (La) based elements such as Tb, Lu, Sc, Gd or the like. In addition, Eu or the like, an activator, maybe substituted with Ce, Tb, Pr, Er, Yb or the like according to an energy level. The activator may be used alone or a sub-activator or the like may be added in order to allow for modification of properties.

Further, as a material for substituting for the phosphor, a material such as a quantum dot (QD) or the like may be used, and the QD or the phosphor may be used alone or a combination of the phosphor and the QD may be used.

The quantum dot (QD) may be configured to have a core (3-10 nm) formed of CdSe, InP, or the like, a shell (0.5˜2 nm) formed of ZnS, ZnSe or the like, and a ligand stabilizing the core and the shell, and may implement various colors depending on a size thereof.

The following Table 1 shows types of phosphors in a white light emitting device using a blue LED chip (440˜460 nm) according to application fields.

TABLE 1

| USAGE | Phosphor |
|---|---|
| LED TV BLU | β-SiAlON:Eu2+ |
| | (Ca, Sr)AlSiN₃:Eu2+ |
| | La₃Si₆N₁₁:Ce3+ |
| | K₂SiF₆:Mn4+ |
| Lighting Apparatuses | Lu₃Al₅O₁₂:Ce3+ |
| | Ca-α-SiAlON:Eu2+ |
| | La₃Si₆N₁₁:Ce3+ |
| | (Ca, Sr)AlSiN₃:Eu2+ |
| | Y₃Al₅O₁₂:Ce3+ |
| | K₂SiF₆:Mn4+ |
| Side View | Lu₃Al₅O₁₂:Ce3+ |
| (Mobile Devices, | Ca-α-SiAlON:Eu2+ |
| Laptop PC) | La₃Si₆N₁₁:Ce3+ |
| | (Ca, Sr)AlSiN₃:Eu2+ |
| | Y₃Al₅O₁₂:Ce3+ |
| | (Sr, Ba, Ca, Mg)2SiO4:Eu2+ |
| | K₂SiF₆:Mn4+ |
| Electronic | Lu₃Al₅O₁₂:Ce3+ |
| Apparatuses | Ca-α-SiAlON:Eu2+ |
| (Headlamps, etc.) | La₃Si₆N₁₁:Ce3+ |
| | (Ca, Sr)AlSiN₃:Eu2+ |
| | Y₃Al₅O₁₂:Ce3+ |
| | K₂SiF₆:Mn4+ |

The exemplary embodiment illustrates that the light emitting device 1000 has a package structure in which the LED chip 1010 is provided within the body 1001 having the reflective cup 1002, but the present disclosure is not limited thereto. For example, the light emitting device 1000 may be the LED chip 1010 itself.

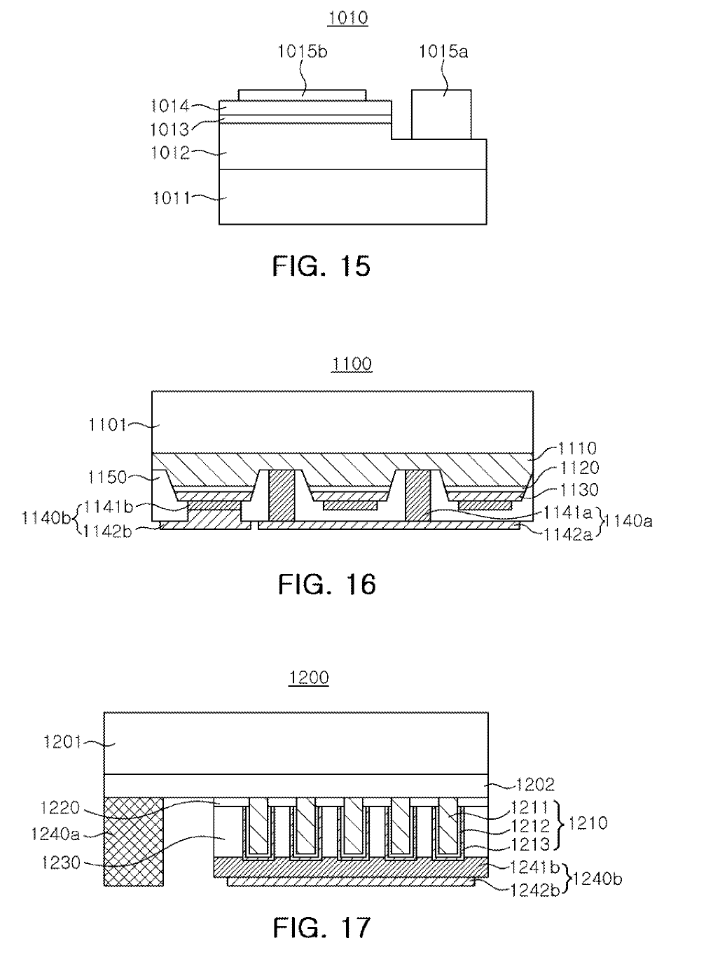

FIGS. 15 through 17 illustrate various examples of LED chips employable in a light emitting device. FIGS. 15 through 17 are cross-sectional views illustrating various examples of a light emitting diode chip employable in a light source module according to an exemplary embodiment of the present disclosure.

Referring to FIG. 15, the LED chip 1010 may include a first conductivity type semiconductor layer 1012, an active layer 1013, and a second conductivity type semiconductor layer 1014 sequentially stacked on a growth substrate 1011.

The first conductivity type semiconductor layer 1012 stacked on the growth substrate 1011 may be an n-type nitride semiconductor layer doped with n-type impurities. The second conductivity type semiconductor layer 1014 may be a p-type nitride semiconductor layer doped with p-type impurities. However, depending on exemplary embodiments, the first and second conductivity type semiconductor layers 1012 and 1014 may be stacked in a state in which positions thereof are altered. The first and second conductivity type semiconductor layers 1012 and 1014 may have a compositional formula of AlₓIn_{y}Ga_{(1-x-y)}N (where, 0≦x<1, 0≦y<1, 0≦x+y<1), and a material having such a composition may be, for example, GaN, AlGaN, InGaN, AlInGaN or the like.

The active layer 1013 disposed between the first and second conductivity type semiconductor layers 1012 and 1014 may emit light having predetermined energy due to the recombination of electrons and holes . The active layer 1013 may contain a material having an energy band gap level lower than that of the first and second conductivity type semiconductor layers 1012 and 1014. For example, in a case in which the first and second conductivity type semiconductor layers 1012 and 1014 are formed of a GaN based compound semiconductor, the active layer 1013 may contain an InGaN based compound semiconductor having an energy band gap level lower than an energy band gap level of GaN. In addition, the active layer 1013 may have a multiple quantum well (MQW) structure in which quantum well and quantum barrier layers are alternately stacked, for example, an InGaN/GaN structure. However, the present disclosure is not limited thereto, and the active layer 1013 may have a single quantum well (SQW) structure.

The LED chip 1010 may include first and second electrode pads 1015a and 1015b electrically connected to the first and second conductivity type semiconductor layers 1012 and 1014, respectively. The first and second electrode pads 1015a and 1015b may be exposed and disposed in the same direction. In addition, the LED chip 1010 may be electrically connected to a substrate in a wire bonding scheme or flip chip bonding scheme.

An LED chip 1110 shown in FIG. 16 may include a semiconductor laminate formed on the growth substrate 1011. The semiconductor laminate may include a first conductivity type semiconductor layer 1110, an active layer 1120, and a second conductivity type semiconductor layer 1130.

The LED chip 1110 may include first and second electrode pads 1140a and 1140b electrically connected to the first and second conductivity type semiconductor layers 1110 and 1130, respectively. The first electrode pad 1140a may include a conductive via 1141a penetrating through the second conductivity type semiconductor layer 1130 and the active layer 1120 to be connected to the first conductivity type semiconductor layer 1110, and an electrode extension part 1142a connected to the conductive via 1141a. The conductive via 1141a may be enclosed by an insulating layer 1150 and be electrically separated from the active layer 1120 and the second conductivity type semiconductor layer 1130. The conductive via 1141a may be disposed in an etched region of the semiconductor laminate. The number, shape, or pitch of conductive vias 1141a or a contact area thereof with respect to the first conductivity type semiconductor layer 1110 may be appropriately designed so as to reduce contact resistance. Further, the conductive vias 1141a may be arranged in a matrix form on the semiconductor laminate, whereby a current flow may be improved. The second electrode pad 1140b may include an ohmic contact layer 1141b and an electrode extension part 1142b on the second conductivity type semiconductor layer 1130.

An LED chip 1200 shown in FIG. 17 may include a growth substrate 1201, a first conductivity type semiconductor base layer 1202 formed on the growth substrate 1201, and a plurality of light emitting nanostructures 1210 formed on the first conductivity type semiconductor base layer 1202. In addition, the LED chip 1200 may further include an insulating layer 1220 and a filling part 1230.

Each of the light emitting nanostructures 1210 may include a first conductivity type semiconductor core 1211, and an active layer 1212 and a second conductivity type semiconductor layer 1213 sequentially formed as shell layers on a surface of the first conductivity type semiconductor core 1211.

The exemplary embodiment illustrates a case in which the light emitting nanostructures 1210 have a core-shell structure, but embodiment in the present disclosure is not limited thereto. The light emitting nanostructures 1210 may have other structures such as a pyramid structure and the like. The first conductivity type semiconductor base layer 1202 may provide a growth surface for growth of the light emitting nanostructure 1210. The insulating layer 1220 may provide open regions for the growth of the light emitting nanostructures 1210 and may be formed of a dielectric material such as SiO₂ or SiNₓ. The filling part 1230 may structurally stabilize the light emitting nanostructures 1210 and allow light to pass therethrough or to be reflected therefrom. Unlike this, in a case in which the filling part 1230 contains a light-transmissive material, the filling part 1230 may be formed of a transparent material such as SiO₂, SiNx, elastic resin, silicon, epoxy resin, polymer or plastics. If necessary, in a case in which the filling part 1230 contains a reflective material, the filling part 1230 may be formed by using a metal power or ceramic powder having a high degree of reflectance in a polymer material such as polypthalamide (PPA). The ceramic powder having a high degree of reflectance may be at least one selected from a group consisting of TiO₂, Al₂O₃, Nb₂O₅, Al₂O₃ and ZnO. Alternatively, a high reflective metal such as aluminum (Al) or silver (Ag) may be used.

First and second electrode pads 1240a and 1240b may be disposed on lower surfaces of the light emitting nanostructures 1210. The first electrode pad 1240a may be positioned on an exposed upper surface of the first conductivity type semiconductor base layer 1202, and the second electrode pad 1240b may include an ohmic contact layer 1241b and an electrode extension part 1242b formed below the light emitting nanostructures 1210 and the filling part 1230. Alternatively, the ohmic contact layer 1241b and the electrode extension part 1242b may be integrally formed.

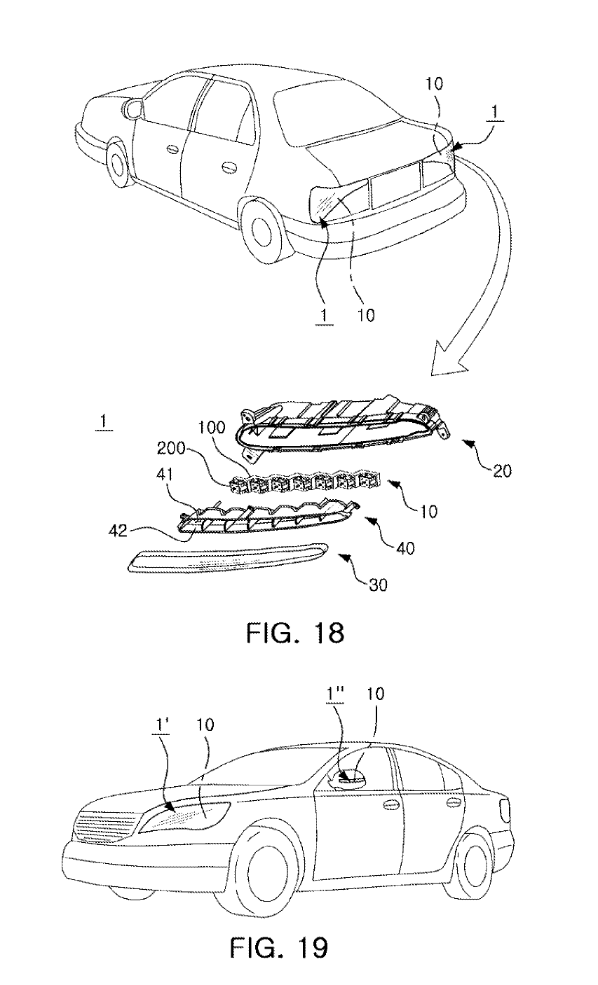

FIG. 18 schematically illustrates a lighting device in which at least one of light source modules according to various exemplary embodiments of the present disclosure is employed. The lighting device according to the exemplary embodiment may include, for example, an automobile rear lamp.

As illustrated in FIG. 18, a lighting device 1 may include a housing 20 supporting the light source module 10, and a cover 30 covering the housing 20 to protect the light source module 10, and a reflector 40 may be disposed on the light source module 10. The reflector 40 may include a plurality of reflective surfaces 41 and a plurality of through holes 42 provided in respective bottom surfaces of the plurality of reflective surfaces 41. The plurality of light emitting units 200 of the light source module 10 may be respectively exposed to the plurality of reflective surfaces 41 through the plurality of through holes 42.

The lighting device 1 may have a generally smooth curved shape corresponding to a shape of an automobile corner portion and thus, the light emitting units 200 may be assembled in the frame part 100 so as to be suitable for the curved shape of the lighting device 1 to thereby form the light source module 10 having a step structure corresponding to the curved shape. Such a structure of the light source module 10 may be variously modified depending on the lighting device 1, that is, the rear lamp. In addition, the number of the correspondingly assembled light emitting units 200 may be variously changed.

Although the exemplary embodiment of the present disclosure illustrates a case in which the lighting device 1 is an automobile rear lamp, but the present disclosure is not limited thereto. For example, as illustrated in FIG. 19, a lighting device 1′ may include an automobile headlamp. In addition, the light source module 10 may be formed to have a multistep structure corresponding to the curved shape of the headlamp.

Further, a lighting device 1″ may include a turn signal indicator mounted on an automobile side mirror. Similarly, the light source module 10 may be easily assembled to have a shape corresponding to a curved shape of the turn signal indicator.

As set forth above, according to an exemplary embodiment of the present disclosure, a light source module allowing for standardization of a structure supporting alight emitting device, the replacement of only a light emitting unit having a broken light emitting device among a plurality of light emitting units, and allowing for easy maintenance, and a lighting device including the same may be provided.

Various advantages and effects in exemplary embodiments of the present disclosure are not limited to the above-described descriptions and may be easily understood through explanations of concrete embodiments of the present disclosure.

While exemplary embodiments have been shown and described above, it will be apparent to those skilled in the art that modifications and variations could be made without departing from the spirit and scope of the present disclosure as defined by the appended claims.

What is claimed is:

1. A light source module, comprising:
a frame part having a plurality of mounting regions positioned on different levels; and
a plurality of light emitting units detachably mounted on the plurality of mounting regions,
wherein each of the plurality of light emitting units includes a base disposed on each mounting region, and a light emitting device disposed above the base and positioned spaced-apart from the mounting region so as to form a space through which air flows, between the mounting region and the light emitting device.

2. The light source module of claim 1, further comprising a clip fixing the plurality of light emitting units to the frame part.

3. The light source module of claim 2, wherein the clip is detachably coupled the frame part and two light emitting units adjacent to each other with a portion of the frame part interposed therebetween, on a bottom of the frame part, and fixes the corresponding light emitting units to the frame part.

4. The light source module of claim 2, wherein the clip has an asymmetrical U-shape in which both end portions thereof have different lengths and are positioned on different levels, the both end portions of the clip being respectively provided with internally protruded protrusions.

5. The light source module of claim 1, wherein the light emitting unit further includes a substrate interposed between the base and the light emitting device.

6. The light source module of claim 5, wherein the base includes a support part above which the light emitting device is mounted and extension parts bent and extended from edges of the support part in a direction opposite to a direction in which the light emitting device is mounted.

7. The light source module of claim 6, wherein the base further includes auxiliary extension parts bent and extended from the remaining edges of the support part in a direction opposite to a direction in which the light emitting device is mounted.

8. The light source module of claim 6, wherein the substrate is disposed on the support part and is extended along the extension parts.

9. The light source module of claim 1, wherein the frame part includes a plurality of first frames respectively having the mounting regions and a plurality of second frames provided between the plurality of first frames and connecting the plurality of first frames to each other.

10. The light source module of claim 9, wherein the plurality of first frames and the plurality of second frames are alternately connected and extended, and the plurality of first frames are formed in a stepped manner so as to be positioned on different levels.

11. The light source module of claim 9, wherein each of the first frames includes a mounting surface on which the light emitting unit is disposed, and side walls forming a space defining each mounting region, together with the mounting surface.

12. The light source module of claim 11, further comprising a heat radiating hole in a central portion of the mounting surface in order to allow air to flow through the heat radiating hole.

13. A lighting device, comprising:
a light source module;
a housing supporting the light source module; and
a cover coupled to the housing and covering the light source module,
wherein the light source module comprises:
a frame part having a plurality of mounting regions positioned on different levels; and
a plurality of light emitting units detachably mounted on the plurality of mounting regions,
wherein each of the plurality of light emitting units includes a base disposed on each mounting region, and a light emitting device disposed above the base and positioned spaced-apart from the mounting region so as to form a space through which air flows, between the mounting region and the light emitting device.

14. The lighting device of claim 13, further comprising:
a reflector reflecting light of the light source module.

15. The lighting device of claim 14, wherein the reflector includes a plurality of reflective surfaces and a plurality of through holes provided in respective bottom surfaces of the plurality of reflective surfaces, and
the plurality of light emitting units of the light source module are respectively exposed to the plurality of reflective surfaces through the plurality of through holes.

16. A light source module, comprising:
a frame part having a plurality of first frames positioned on different levels, each first frame including a side wall and a plurality of guide members protruding from a mounting surface of said each first frame; and
a plurality of light emitting units, each including a light emitting device, and a base including a support part on which the light emitting device is mounted and extension parts bent and extended from edges of the support part in a direction opposite to a direction in which the light emitting device is mounted,
wherein the extension parts of the base of one of the plurality of light emitting units are detachably mounted between the guide members and the side wall of one of the plurality of first frames.

17. The light source module of claim 16, wherein a length of the extension parts is greater than a protruded length of the guide members so as to form a space through which air flows, between the mounting surface and the light emitting device.

18. The light source module of claim 16, further comprising a clip fixing the plurality of light emitting units to the frame part.

19. The light source module of claim 18, wherein the clip is detachably coupled the frame part and two light emitting units adjacent to each other with a portion of the frame part interposed therebetween, on a bottom of the frame part, and fixes the corresponding light emitting units to the frame part.

20. The light source module of claim 18, wherein the clip has an asymmetrical U-shape in which both end portions thereof have different lengths and are positioned on different levels, the both end portions of the clip being respectively provided with internally protruded protrusions.
